(19) United States
(12) Patent Application Publication
(10) Pub. No.: US 2024/0178434 A1
(43) Pub. Date: May 30, 2024

(54) BATTERY AND ELECTRONIC APPARATUS CONTAINING SAME

(71) Applicant: Ningde Amperex Technology Limited, Ningde (CN)

(72) Inventors: Yuyang DONG, Ningde (CN); Dongyang YAN, Ningde (CN); Qiao ZENG, Ningde (CN)

(73) Assignee: Ningde Amperex Technology Limited, Ningde (CN)

(21) Appl. No.: 18/437,277

(22) Filed: Feb. 9, 2024

Related U.S. Application Data
(63) Continuation of application No. PCT/CN2021/112219, filed on Aug. 12, 2021.

(51) Int. Cl. H01M 10/04; H01M 10/42; H01M 50/105; H01M 50/131; H01M 50/533; H01M 50/534; H01M 50/536

(52) U.S. Cl. CPC H01M 10/0431; H01M 10/4221; H01M 50/105; H01M 50/131; H01M 50/533; H01M 50/534; H01M 50/536; H01M 2220/30

(57) ABSTRACT

An electrode assembly includes a stacked portion and a second layer. The stacked portion includes a first layer disposed between a first conductive layer and a second conductive layer. The stacked portion is a wound structure including a first surface and a first end portion. The second layer is connected to the first surface. When viewed in the first direction, the first surface has a first region located on a first side of the first end portion and a second region located on a second side of the first end portion. In a second direction perpendicular to the first direction, the first side and the second side are located on two opposite sides of the first end portion. When viewed in a winding direction of the stacked portion, the second region is closer to the first end portion than the first region.

### CROSS-REFERENCE TO RELATED APPLICATION

This application is a continuation of International Patent Application No. PCT/CN2021/112219, filed on Aug. 12, 2021, the disclosure of which is hereby incorporated by reference in its entirety.

### TECHNICAL FIELD

This application relates to the field of energy storage apparatuses, and in particular, to a battery and an electronic apparatus containing the battery.

### BACKGROUND

Currently, terminal devices powered by electrical energy are developing towards mobility and portability. If an abnormality occurs in the battery of terminal devices during use, users would visit the after-sales service center of the terminal device to replace the battery. Both users and manufacturers have a demand for finding the cause of the battery abnormality. Therefore, unique identification codes for battery can be convenient for troubleshooting and tracing. A conventional battery has an identification code on its packaging housing, but collisions, friction, and the like may occur during use of the battery, leading to illegible identification codes.

### SUMMARY

An objective of this application is to provide a battery capable of suppressing occurrence of unrecognizable identification portions caused by external forces.

Some embodiments of this application provide a battery including an electrode assembly, and the electrode assembly includes a stacked portion and a second layer. The stacked portion includes a first conductive layer, a second conductive layer, and a first layer containing an insulating material and arranged between the first conductive layer and the second conductive layer. The stacked portion is configured as a wound structure and further includes a first surface and a first end portion. The thickness direction of the electrode assembly is defined as the first direction. When viewed in the first direction, the first surface has a first region located a first side of the first end portion and a second region located on a second side of the first end portion. In a second direction perpendicular to the first direction, the first side and the second side are located on two opposite sides of the first end portion. In the winding direction of the stacked portion, the second region is closer to the first end portion than the first region. The second layer covers at least a portion of the first end portion and is connected to the first region and the second region, and the second layer is provided with an identification portion.

In this application, the identification portion is disposed on the electrode assembly instead of the housing, thereby reducing risk of the identification portion becoming unrecognizable due to external forces such as impact and friction on the battery.

According to some embodiments of this application, when viewed in the first direction, the second layer includes a first portion overlapping with the first region and a second portion overlapping with the second region, and the identification portion is disposed on either the first portion or the second portion away from the first end portion.

According to some embodiments of this application, the identification portion is disposed on the one with a larger area of the first portion and the second portion. Disposing the identification portion on the one with a larger area of the first portion and the second portion of the second layer reduces probability of falling off the surface of the stacked portion under external forces, thus reducing the risk of smearing and deformation caused by falling of the second layer off the electrode assembly.

According to some embodiments of this application, the identification portion is disposed on the one with a smaller area of the first portion and the second portion.

According to some embodiments of this application, when viewed in the first direction, the identification portion covers at least a portion of the first end portion.

According to some embodiments of this application, when viewed in the first direction, the stacked portion has a third end portion and a fourth end portion located opposite the third end portion in the second direction; and when viewed in the first direction, the second layer is arranged from the third end portion to the fourth end portion. Arranging the second layer from the third end portion to the fourth end portion enlarges a contact area between the second layer and the first surface, which in turn improves adhesion between the second layer and the first surface.

According to some embodiments of this application, when viewed in the first direction, in the third direction perpendicular to the first direction and the second direction, the stacked portion has a fifth end portion and a sixth end portion located opposite the fifth end portion; and when viewed in the first direction, the second layer is disposed away from the fifth end portion and the sixth end portion.

According to some embodiments of this application, in the third direction, the second layer has a seventh end portion located on the side of the fifth end portion and an eighth end portion located opposite the seventh end portion and on the side of the sixth end portion; and in the third direction, a distance from the fifth end portion to the seventh end portion is shorter than a distance from the sixth end portion to the eighth end portion.

According to some embodiments of this application, the electrode assembly further includes a first metal plate, and the first metal plate is connected to the first conductive layer. When viewed in the first direction, the first metal plate has a portion overlapping with the fifth end portion.

According to some embodiments of this application, in the second direction, a distance from the first end portion to the third end portion is longer than a distance from the first end portion to the fourth end portion.

According to some embodiments of this application, the stacked portion further includes a first bent portion, a second bent portion located opposite the first bent portion in the second direction, a first surface portion located between the first bent portion and the second bent portion when viewed in the first direction, and a second surface portion located between the first bent portion and the second bent portion and facing the first surface portion when viewed in the first direction.

According to some embodiments of this application, the second layer is connected to all of the first surface portion, the first bent portion, and the second bent portion. Extending the second layer from the first surface portion to the first bent portion and the second bent portion can improve the adhesion between the second layer and the stacked portion.

According to some embodiments of this application, the second layer is connected to all of the first surface portion, the first bent portion, the second bent portion, and the second surface portion.

According to some embodiments of this application, the identification portion is provided in a winding direction of the stacked portion away from the first bent portion and the second bent portion, allowing for more clearly display of the identification portion.

According to some embodiments of this application, when viewed in the first direction, the stacked portion has a third end portion and a fourth end portion located opposite the third end portion in the second direction, and the stacked portion has a fifth end portion and a sixth end portion located opposite the fifth end portion in a third direction perpendicular to the first direction and the second direction.

According to some embodiments of this application, when viewed in the first direction, the electrode assembly includes a third layer containing an insulating material, and the third layer is connected to the first surface and has a portion overlapping with the sixth end portion. In the third direction, the third layer is disposed away from the second layer.

According to some embodiments of this application, the third layer is connected to both the first surface portion and the second surface portion. Connecting the third layer to both the first surface portion and the second surface portion can press tight the stacked portion in the first direction, thereby reducing risk of displacement of the first conductive layer, the second conductive layer, or the first layer.

According to some embodiments of this application, the third layer has a ninth end portion and a tenth end portion located opposite the ninth end portion in the third direction, and the second layer has a seventh end portion and an eighth end portion located opposite the seventh end portion and on the side of the tenth end portion in the third direction. In the third direction, a distance from the eighth end portion to the ninth end portion is different from a distance from the ninth end portion to the tenth end portion.

According to some embodiments of this application, the distance from the eighth end portion to the ninth end portion is shorter than the distance from the ninth end portion to the tenth end portion.

According to some embodiments of this application, the first conductive layer includes a first current collector and a first active substance layer.

According to some embodiments of this application, the first current collector includes at least one of Ni, Ti, Cu, Ag, Au, Pt, Fe, Co, Cr, W, Mo, Al, Mg, K, Na, Ca, Sr, Ba, Si, Ge, Sb, Pb, In, Zn, or a composition thereof, and the first active substance layer includes at least one of lithium cobalt oxide, lithium manganese oxide, lithium nickel oxide, lithium nickel cobalt manganese oxide, lithium iron phosphate, lithium manganese iron phosphate, lithium vanadium phosphate, lithium vanadyl phosphate, lithium-rich manganese-based material, lithium nickel cobalt aluminum oxide, lithium titanium oxide, or a composition thereof.

According to some embodiments of this application, the electrode assembly further includes a second metal plate, the second metal plate is welded to the outermost second conductive layer of the wound structure formed by winding the stacked portion, a welding mark is formed between the second metal plate and the second conductive layer, the stacked portion further includes a second surface located opposite the first surface, the second surface is provided with a fourth layer, and when viewed in the first direction, the fourth layer covers the welding mark. The fourth layer separates the welding mark from the housing, suppressing the phenomenon of the welding mark protruding through the housing.

According to some embodiments of this application, the battery further includes a housing accommodating the electrode assembly.

According to some embodiments of this application, at least a portion of the inner side of the housing facing the surface of the electrode assembly has a conductive material.

An embodiment of this application further provides an electronic apparatus containing any one of the foregoing batteries.

### BRIEF DESCRIPTION OF DRAWINGS

The above and/or additional aspects and advantages of this application will become obvious and easy to understand from the description of the embodiments with reference to the following drawings.

FIG. 1 is a side view of a battery according to an embodiment of this application;

FIG. 2 is a side view of an electrode assembly of the battery shown in FIG. 1;

FIG. 3 is a front schematic view of the battery shown in FIG. 1;

FIG. 4 is a front schematic view of the electrode assembly shown in FIG. 2;

FIG. 5 is a rear schematic view of the electrode assembly shown in FIG. 2;

FIG. 6 is a sectional view along V-V of the electrode assembly shown in FIG. 2;

FIG. 7 is a left view of the electrode assembly shown in FIG. 2;

FIG. 8 is a right view of the electrode assembly shown in FIG. 2;

FIG. 9 is a front schematic view of an electrode assembly according to another embodiment of this application;

FIG. 10 is a front schematic view of an electrode assembly according to another embodiment of this application;

FIG. 11 is a front schematic view of an electrode assembly according to another embodiment of this application;

FIG. 12 is a front schematic view of an electrode assembly according to another embodiment of this application;

FIG. 13 is a front schematic view of an electrode assembly according to another embodiment of this application;

FIG. 14 is a front schematic view of an electrode assembly according to another embodiment of this application;

FIG. 15 is a rear schematic view of the electrode assembly according to another embodiment of this application;

FIG. 16 is a rear schematic view of the electrode assembly according to another embodiment of this application;

FIG. 17 is a side view of an electrode assembly according to another embodiment of this application;

FIG. 18 is a front schematic view of the electrode assembly shown in FIG. 17;

FIG. 19 is a rear schematic view of the electrode assembly shown in FIG. 17;

FIG. 20 is a sectional schematic view of the first conductive layer of the electrode assembly shown in FIG. 6 after unfolding;

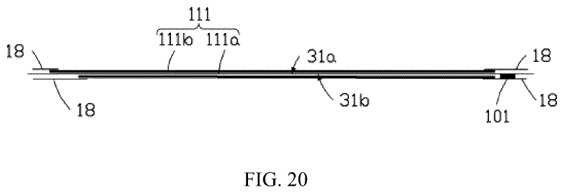

FIG. 21A is a sectional schematic view of the second conductive layer of the electrode assembly shown in FIG. 6 after unfolding;

FIG. 21B is a bottom view of the second conductive layer of the electrode assembly shown in FIG. 6 after unfolding;

FIG. 22 is a rear schematic view of the electrode assembly according to another embodiment of this application; and

FIG. 23 is a structural schematic view of an electronic apparatus according to an embodiment of this application.

### REFERENCE SIGNS OF MAIN COMPONENTS

Battery 100
Electrode assembly 10
Housing 20
First metal plate 101
Second metal plate 102
Stacked portion 11
Second layer 12
First conductive layer 111
Second conductive layer 112
First layer 113
First surface 110
First end portion 11a
Second end portion 11b
Second surface 120
First region 110a
Second region 110b
First portion 121
Second portion 122
Identification portion 30
Third end portion 11c
Fourth end portion 11d
Fifth end portion 11e
Sixth end portion 11f
Seventh end portion 12a
Eighth end portion 12b
First bent portion 115
Second bent portion 116
First surface portion 117
Second surface portion 118
First end 11A
Second end 11B
Third end 11C
Fourth end 11D
First overlapping region 14a
Second overlapping region 14b
Third overlapping region 14
Fourth overlapping region 14d
Third layer 17
Ninth end portion 17a
Tenth end portion 176
First current collector 111a
First active substance layer 111b
First face 31a
Second face 31b
Fifth layer 18
Second current collector 112a
Second active substance layer 112b
Third face 41a
Fourth face 41b
Second welding mark 105
Fourth layer 19
Electronic apparatus 200
Display screen 210
First side edge 113a
Body 220

### DETAILED DESCRIPTION

The following clearly and detailedly describes the technical solutions in the embodiments of this application. Apparently, the described embodiments are only some rather than all of the embodiments of this application. Unless otherwise defined, all technical and scientific terms used herein shall have the same meanings as commonly understood by persons skilled in the art to which this application pertains. The terms used in the specification of this application are merely intended to describe specific embodiments but not intended to constitute any limitation on this application.

The following describes the embodiments of this application in detail. However, this application may be embodied in many different implementations and should not be construed as being limited to the example embodiments set forth herein. Rather, these example embodiments are provided so that this application can be conveyed to those skilled in the art thoroughly and in detail.

In addition, in the accompanying drawings, sizes or thicknesses of various components and layers may be exaggerated for brevity and clarity. Throughout the text, the same numerical values represent the same elements. As used herein, the term “and/or” includes any and all combinations of one or more of the associated listed items. In addition, it should be understood that when an element A is referred to as being “connected to” an element B, the element A can be directly connected the element B or an intervening element C may be present therebetween such that the element A and the element B are indirectly connected to each other.

Further, the use of “may” when describing embodiments of this application relates to “one or more embodiments of this application.”

The terminology used herein is merely intended to describe specific embodiments but not intended to constitute any limitation on this application. As used herein, the singular forms are intended to include the plural forms as well, unless the context clearly indicates otherwise. It should be further understood that the terms “comprise” or “include” and variations thereof, when used in this specification, specify the presence of stated features, numbers, steps, operations, elements, and/or components but do not preclude the presence or addition of one or more other features, numbers, steps, operations, elements, components, and/or groups thereof.

Spatial related terms such as “above” may be used herein for ease of description to describe the relationship between one element or feature and another element (a plurality of elements) or feature (a plurality of features) as illustrated in the figure. It should be understood that spatial related terms are intended to encompass different orientations of a device or an apparatus in use or operation in addition to the orientations depicted in the figures. For example, if the device in the figures is turned over, elements described as “above” or “over” other elements or features would then be oriented “below” or “beneath” the other elements or features. Thus, the example term “above” can encompass both an orientation of above and below. It should be understood that although the terms first, second, third, or the like may be used herein to describe various elements, components, zones, layers, and/or portions, these elements, components, zones, layers, and/or portions should not be limited by these terms. These terms are used to distinguish one element, component, region, layer, or portion from another element, component, region, layer, or portion. Therefore, the first element, component, region, layer, or portion discussed below may be referred to as the second element, component, region, layer, or portion without departing from the teachings of the example embodiments.

In this application, X direction (first direction) refers to the thickness direction of the stacked portion. Y direction (second direction) refers to the direction extending from the second region on the first surface toward the first region thereof and perpendicular to the X direction. Z direction (third direction) refers to the extension direction of the first metal plate and perpendicular to the X direction.

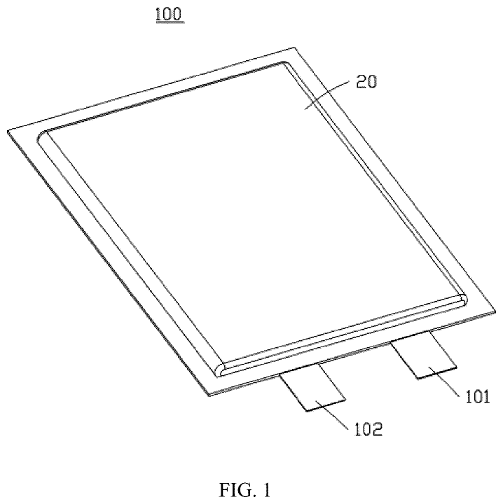

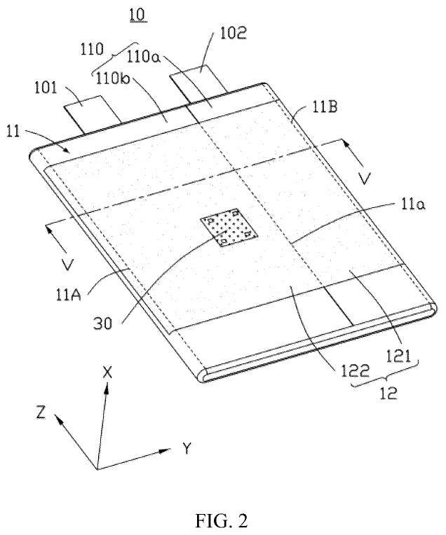

Referring to FIG. 1 and FIG. 2, an embodiment of this application provides a battery 100 including an electrode assembly 10 and a housing 20 accommodating the electrode assembly 10. The first metal plate 101 and the second metal plate 102 of the electrode assembly 10 extend from one end of the housing 20 to connect external components. In some embodiments, at least a portion of the inner side of the housing facing the electrode assembly 10 may have an electrically conductive material to improve mechanical strength of the housing 20. The housing 20 may be a metal housing, such as a steel or aluminum housing. In other embodiments, the housing 20 can also be a packaging bag obtained by packaging with a packaging film, that is, the battery 100 is a pouch battery.

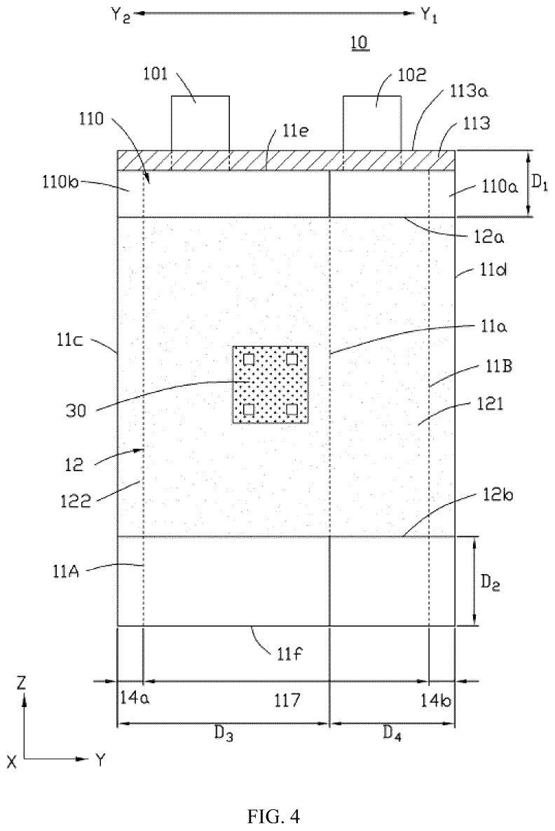

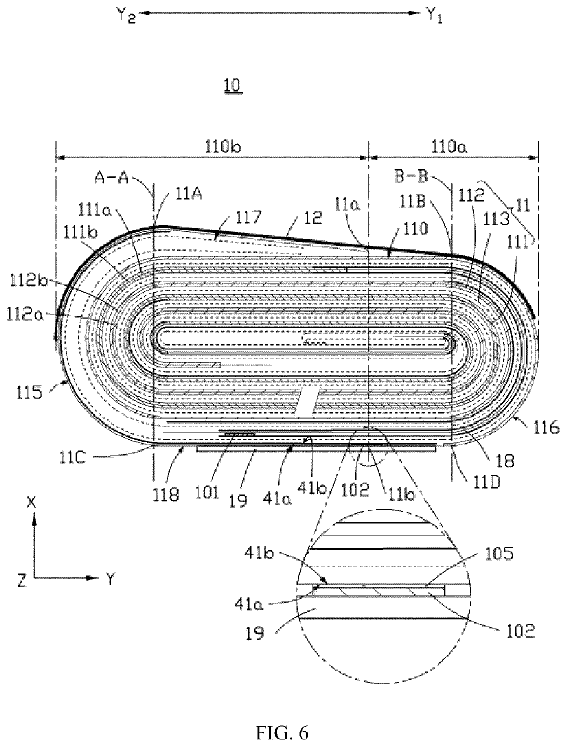

Referring to FIG. 2, FIG. 4 and FIG. 6, the electrode assembly 10 includes a stacked portion 11 and a second layer 12. The stacked portion 11 includes a first conductive layer 111, a second conductive layer 112, and a first layer 113 disposed between the first conductive layer 111 and the second conductive layer 112. The first layer 113 is used to prevent direct contact between the first conductive layer 111 and the second conductive layer 112, thereby reducing the risk of contact short circuit between the first conductive layer 111 and the second conductive layer 112. The first layer 113 includes an insulating material. The insulating material is at least one selected from polypropylene, polyethylene, polyvinylidene fluoride, vinylidene fluoride-hexafluoropropylene copolymer, polymethyl methacrylate, or polyethylene glycol. The stacked portion 11 is configured as a wound structure.

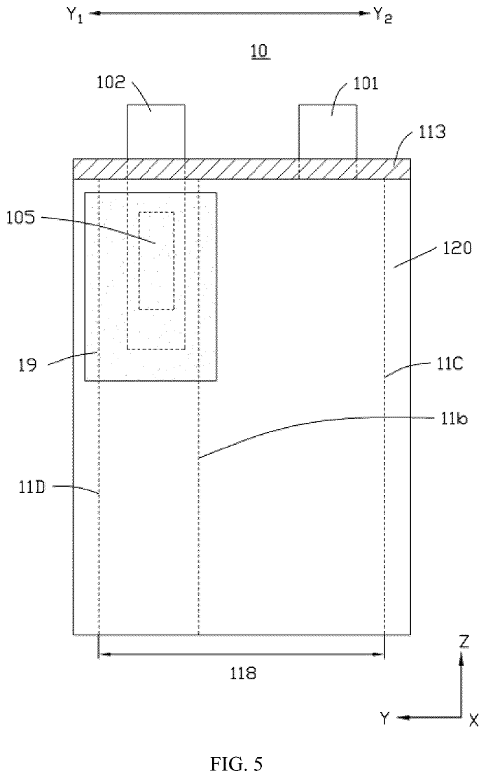

The stacked portion 11 includes a first surface 110, a first end portion 11a, a second end portion 11b located opposite the first end portion 11a (referring to FIG. 5), and a second surface 120 located opposite the first surface 110 (referring to FIG. 5). The second layer 12 is connected to the first surface 110. The first end portion 11a refers to an end portion that is of the outermost first conductive layer 111, second conductive layer 112, or first layer 113 of the wound structure and that is exposed outside the wound structure when viewed in the winding direction. In FIG. 6, the second conductive layer 112 is located on the outermost side of the wound structure, and the first end portion 11a refers to an end portion of the second conductive layer 112 that is exposed outside the wound structure when viewed in a winding direction. In this embodiment, the second conductive layer 112 serves as a negative electrode, and the first conductive layer 111 serves as a positive electrode.

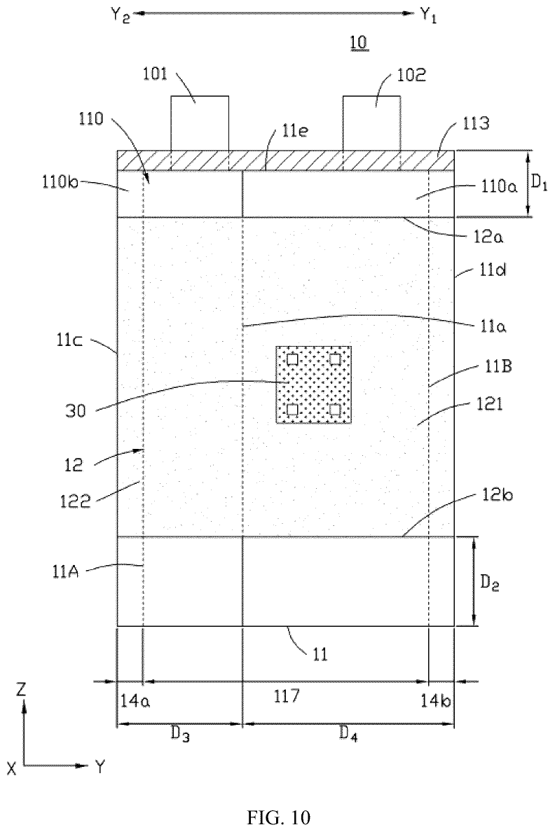

When viewed in the X direction, the first surface 110 has a first region 110a on a first side Y1 of the first end portion 11a in the Y direction and a second region 110b on a second side Y2 that is of the first end portion 11a and that is located opposite the first side Y1 in the Y direction. When viewed in the winding direction of the stacked portion, the second region 110b is closer to the first end portion 11a than the first region 110a. The second layer 12 is in the form of a sheet, covers at least a portion of the first end portion 11a, and is connected to the first region 110a and the second region 110b. The surface of the second layer 12 includes a first portion 121 overlapping with the first region 110a and a second portion 122 overlapping with the second region 110b when viewed in the X direction. The one with a larger area of the first portion 121 and the second portion 122 is provided with an identification portion 30 disposed away from the first end portion 11a. In FIG. 4, the area of the second portion 122 is larger than that of the first portion 121, and the identification portion 30 is disposed on the second portion 122 away from the first end portion 11a. In FIG. 10, the area of the first portion 121 is larger than that of the second portion 122, and the identification portion 30 is disposed on the first portion 121 away from the first end portion 11a. The one with a larger area of the first portion 121 and the second portion 122 exhibits stronger adhesion to the first surface 110. Under external forces, the one with a larger area has a lower probability of falloff. Disposing the identification portion 30 on the one with the larger area can reduce the risk of smearing and deformation resulting from falling of the second layer 12 off the first surface 110.

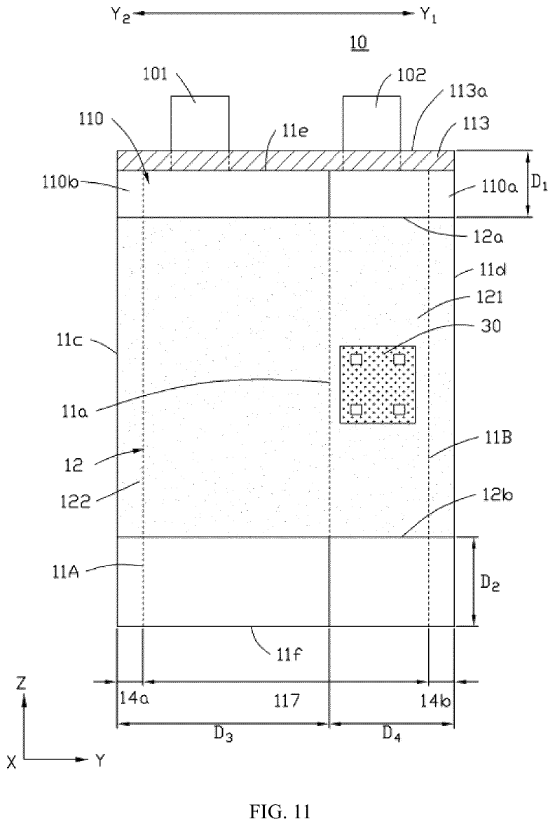

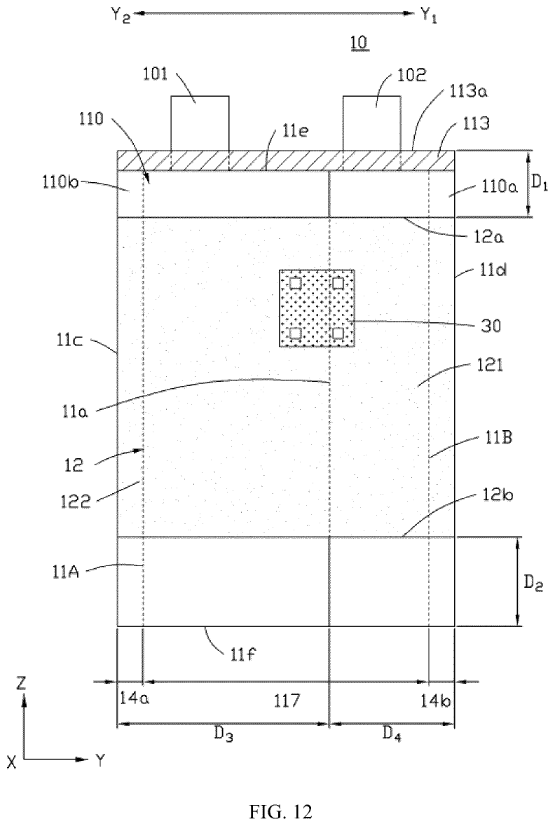

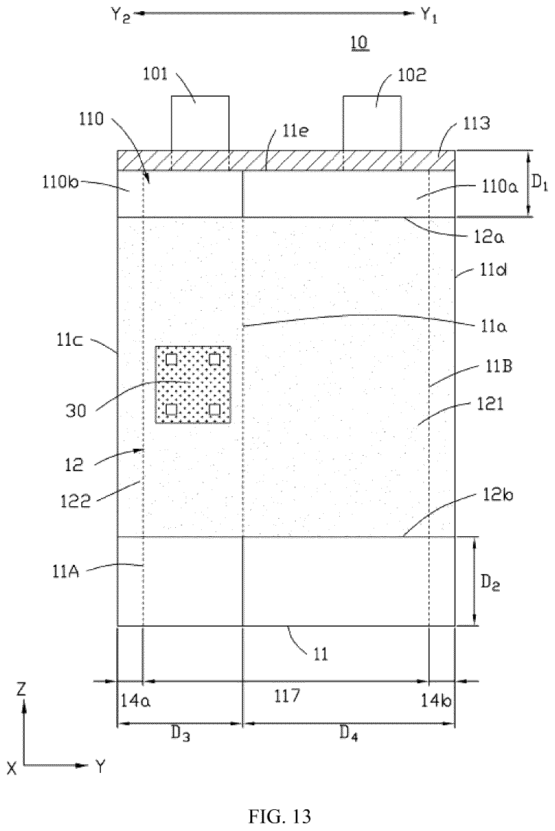

In some embodiments, the identification portion 30 is disposed on the one with a smaller area of the first portion 121 and the second portion 122, away from the first end portion 11a. Referring to FIG. 11, the area of the first portion 121 is smaller than that of the second portion 122, and the identification portion 30 is disposed on the first portion 121 away from the first end portion 11a. Referring to FIG. 13, the area of the second portion 122 is smaller than that of the first portion 121, and the identification portion 30 is disposed on the second portion 122 away from the first end portion 11a. In some other embodiments, referring to FIG. 12, the identification portion 30 is disposed on both the first portion 121 and the second portion 122 and covers at least a portion of the first end portion 11a.

In some embodiments, the second layer 12 includes an insulating material, and the insulating material is selected from at least one of polyethylene, polypropylene, phenolic resin, melamine resin, unsaturated polyester resin, epoxy resin, silicone resin, or polyurethane.

In some embodiments, the identification portion 30 is a combination of one or more of patterns, letters, numbers, text, one-dimensional barcodes, two-dimensional barcodes, three-dimensional barcodes, entry labels, and electronic tags. The identification portion 30 is used for expressing identification information. The identification information expressed by the identification portion 30 may include at least one of type and/or model of the battery, manufacturer and/or distributor, batch number, production date, or service life. The identification portion 30 can be formed by one or more of printing, surface treatment, or pasting.

When viewed in the X direction, the stacked portion 11 has a third end portion 11c and a fourth end portion 11d located opposite the third end portion 11c in the Y direction. The second layer 12 is arranged from the third end portion 11c to the fourth end portion 11d. When viewed in the X direction, the first conductive layer 111 in the Z direction has a fifth end portion 11e and a sixth end portion 11f located opposite the fifth end portion 11e. In the Z direction, the fifth end portion 11e and the sixth end portion 11f extend beyond the two end portions of the second conductive layer in the Z direction, respectively. The first layer 113 in the Z direction has a first side edge 113a and a second side edge (not shown in the figure) located opposite the first side edge 113a. The first side edge 113a and the second side edge extend beyond the fifth end portion 11e and the sixth end portion 11f, respectively. When viewed in the X direction, the second layer 12 is disposed away from the fifth end portion 11e and the sixth end portion 11f. In the Z direction, the second layer 12 has a seventh end portion 12a located on the side of the fifth end portion 11e and an eighth end portion 12b located opposite the seventh end portion 12a and on the side of the sixth end portion 11f. There are preset distances between the fifth end portion 11e and the seventh end portion 12a, as well as between the sixth end portion 11f and the eighth end portion 12b. In some embodiments, in the Z direction, a distance D1 between the fifth end portion 11e and the seventh end portion 12a is shorter than a distance D2 between the sixth end portion 11f and the eighth end portion 12b. In some embodiments, in the Y direction, a distance D3 between the first end portion 11a and the third end portion 11c is longer than a distance D4 between the first end portion 11a and the fourth end portion 11d.

The first metal plate 101 is connected to the first conductive layer 111 and extends from one end of the housing 20 to connect external components. The second metal plate 102 is connected to the second conductive layer 112 and extends from the same end of the housing 20 as the first metal plate 101 to connect external components. When viewed in the X direction, both the first metal plate 101 and the second metal plate 102 have overlapping portions with the fifth end portion 11e.

Referring to FIG. 6, the stacked portion 11 further includes a first bent portion 115, a second bent portion 116 located opposite the first bent portion 115 in the Y direction, a first surface portion 117 located between the first bent portion 115 and the second bent portion 116 when viewed in the X direction, and a second surface portion 118 facing towards an opposite face of the first surface portion 117 and located between the first bent portion 115 and the second bent portion 116 when viewed in the λ direction. A joint between the outermost first bent portion 115 of the stacked portion 11 disposed as the wound structure and the outermost first surface portion 117 of the stacked portion 11 is a first end 11A. The first end 11A represents a tail portion of a curve located on the second side Y2 in the winding direction in FIG. 6, and also represents a portion where a dashed line AA formed by an innermost bent edge of the electrode assembly 10 on the second side Y2 extending in the X direction intersects with the first surface 110. A joint between the outermost second bent portion 116 of the stacked portion 11 and the outermost first surface portion 117 of the stacked portion 11 is a second end 11B. The second end 11B represents a starting portion of a curve located on the first side Y1 in the winding direction in FIG. 6, and it also represents a portion where a dashed line BB formed by an innermost bent edge of the electrode assembly on the first side Y1 extending in the X direction intersects with the first surface 110. A joint of the outermost first bent portion 115 of the stacked portion 11 and the outermost second surface portion 118 of the stacked portion 11 is a third end 11C. The third end 11C represents a starting portion of a curve located on the second side Y2 in the winding direction in FIG. 6, and also represents a portion where the dashed line AA formed by an innermost bent edge of the electrode assembly 10 on the second side Y2 extending in the X direction intersects with the second surface 120. A joint between the outermost second bent portion 116 of the stacked portion 11 and the outermost second surface portion 118 of the stacked portion 11 is a fourth end 11D. The fourth end 11D represents a tail portion of a curve located on the first side Y1 in the winding direction in FIG. 6, and also represents a portion where the dashed line BB formed by an innermost bent edge of the electrode assembly 10 on the first side Y1 extending in the X direction intersects with the second surface 120. In the X direction, the first end 11A aligns with the third end 11C, and the second end 11B aligns with the fourth end 11D. The second layer 12 is connected to all of the first surface portion 117, the first bent portion 115, and the second bent portion 116. Referring to FIG. 4, when viewed in the X direction, the first surface portion 117 overlaps with the first surface 110, the first surface 110 and the first bent portion 115 have a first overlapping region 14a, and the first surface 110 and the second bent portion 116 have a second overlapping region 14b. The second layer 12 covers at least a portion of any one of the first surface portion 117, the first overlapping region 14a, or the second overlapping region 14b. When viewed in the Y direction, the identification portion 30 is disposed away from the first end 11A and the second end 11B. This means that the identification portion is disposed away from the first bent portion 115 and the second bent portion 116 in the winding direction, allowing for a clearer display of the identification portion 30.

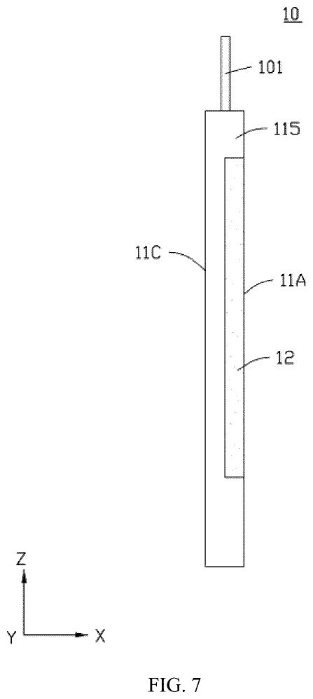

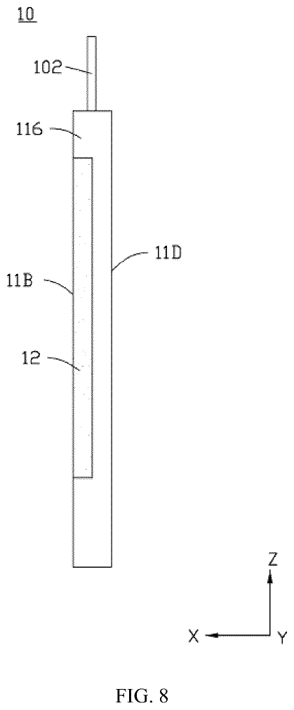

Referring to FIG. 7, when viewed in the Y direction, the second layer 12 is arranged from the first end 11A and covers part of the first bent portion 115. In some embodiments, when viewed in the Y direction, the second layer 12 can be arranged from the first end 11A to the third end 11C, or the second layer 12 may not be connected to the first bent portion 115. Referring to FIG. 8, when viewed in the Y direction, in the X direction, the second layer 12 is arranged from the second end 11B and covers part of the second bent portion 116. In some embodiments, when viewed in the Y direction, the second layer 12 can be arranged from the second end 11B to the fourth end 11D, or the second layer 12 may not be connected to the second bent portion 116.

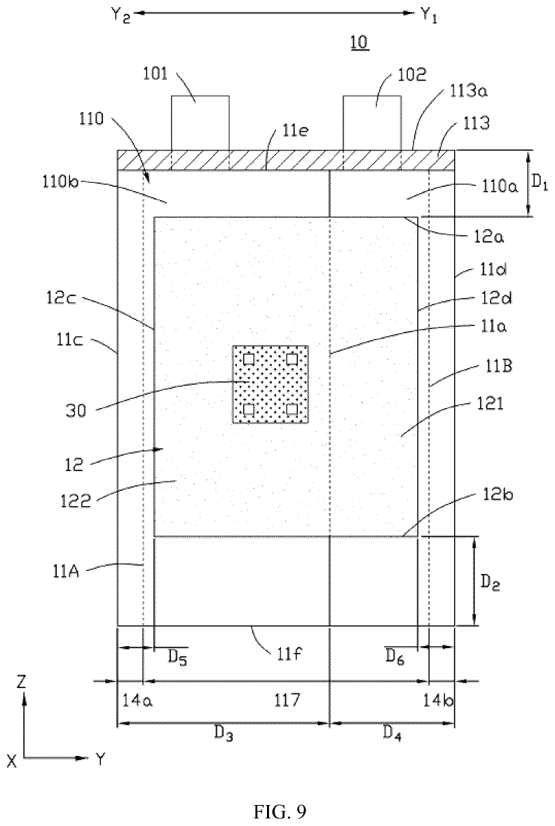

Referring to FIG. 9, in some embodiments, when viewed in the X direction, the second layer 12 covers part of the first surface 110 in the Y direction. When viewed in the X direction, the second layer 12 in the Y direction has an eleventh end portion 12c located on the side of the third end portion 11c and a twelfth end portion 12d located opposite the eleventh end portion 12c and on the side of the fourth end portion 11d. The eleventh end portion 12c is disposed away from the third end portion 11c, and the twelfth end portion 12d is disposed away from the fourth end portion 11d. In some other embodiments, when viewed in the X direction, either the eleventh end portion 12c or the twelfth end portion 12d can be disposed away from the corresponding third end portion 11c or fourth end portion 11d, while the other end portion can be connected to the corresponding third end portion 11c or fourth end portion 11d. In FIG. 9, a distance D5 between the eleventh end portion 12c and the third end portion 11c is equal to a distance D6 between the twelfth end portion 12d and the fourth end portion 11d. In addition, the eleventh end portion 12c and the twelfth end portion 12d are disposed away from the first end 11A and the second end 11B, respectively.

Referring to FIG. 13, in some embodiments, when viewed in the X direction, the second layer 12 overlaps with the sixth end portion 11f. The eighth end portion 12b overlaps with the sixth end portion 11f. When viewed in the X direction, the second layer 12 is arranged from the sixth end portion 11f in the Z direction and is disposed away from the fifth end portion 11e. Increasing the area of the second layer 12 can improve the adhesion between the second layer 12 and the first surface 110, thereby reducing the risk of falloff of the second layer 12 from the first surface 110.

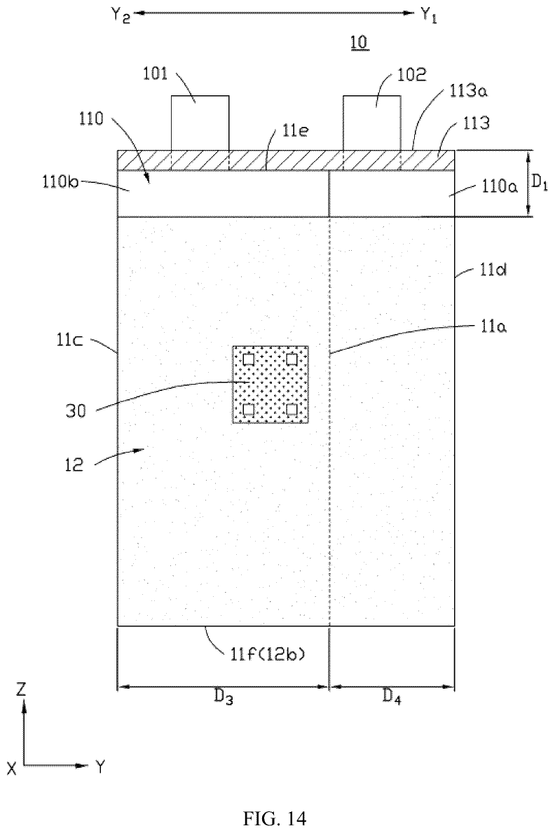

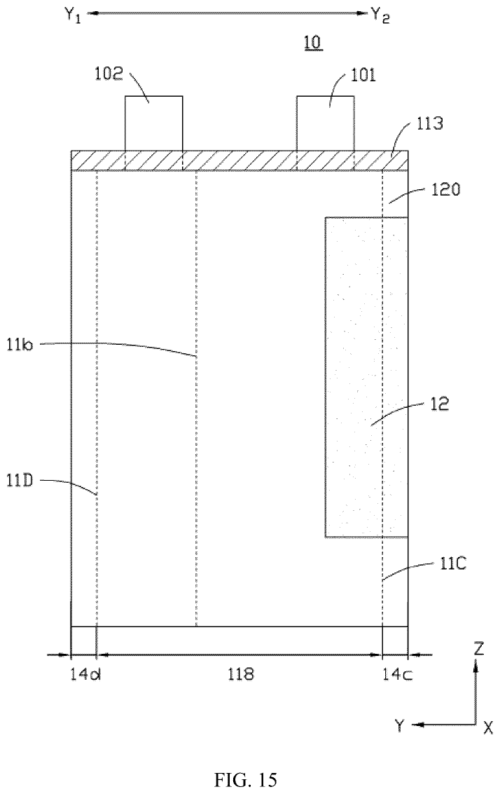

Referring to FIG. 14, the second layer 12 is further connected to the second surface portion 118. When viewed in the X direction, the second surface portion 118 overlaps with the second surface 120. The second surface 120 and the first bent portion 115 have a third overlapping region 14c, and the second surface 120 and the second bent portion 116 have a fourth overlapping region 14d. When viewed in the X direction, the second layer 12 in the Y direction further covers part of the third overlapping region 14c and the second surface portion 118. In some embodiments, referring to FIG. 15, when viewed in the X direction, the second layer 12 further covers the third overlapping region 14c, the second surface portion 118, and the fourth overlapping region 14d in the Y direction.

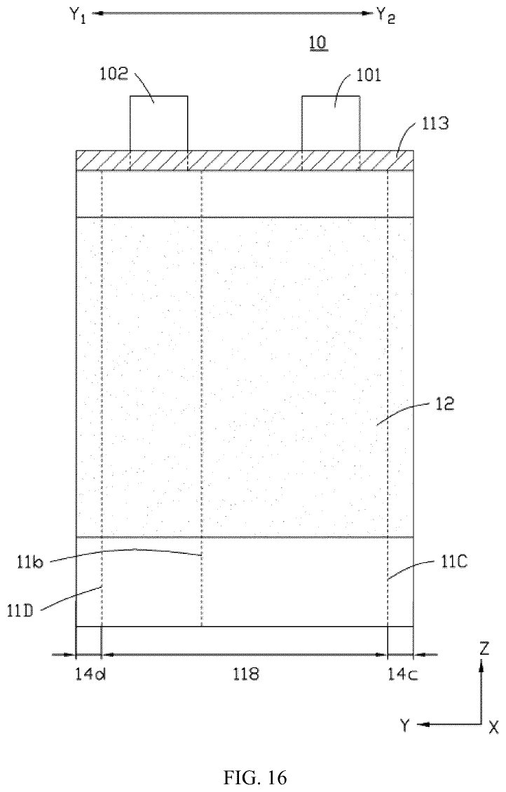

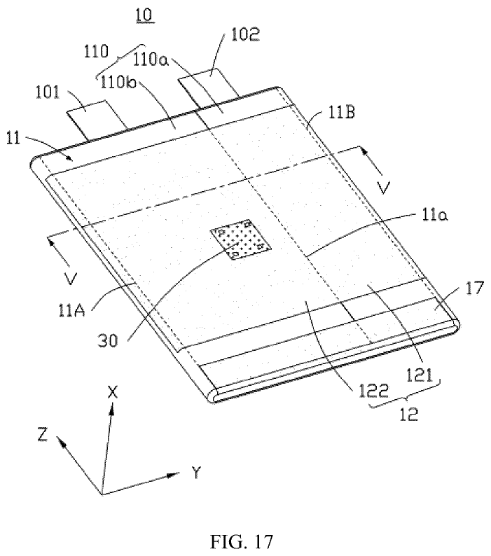

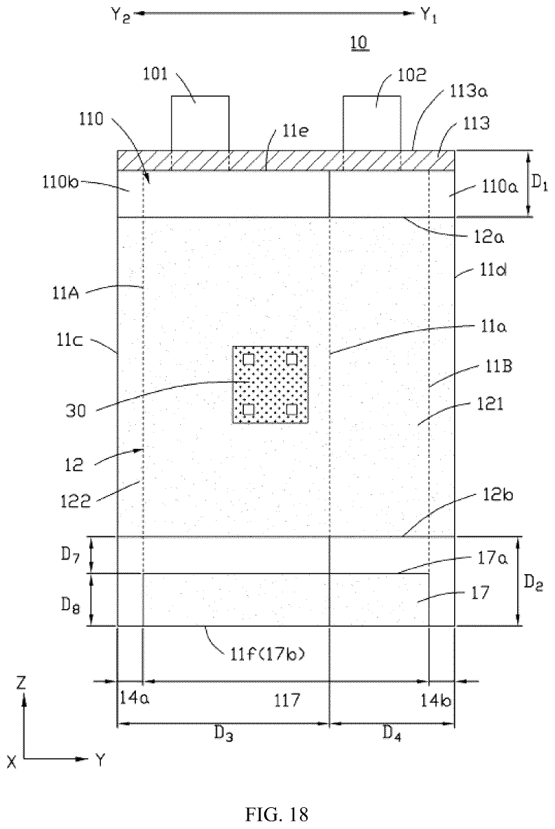

Referring to FIG. 16, FIG. 17 and FIG. 18, the electrode assembly 10 further includes a third layer 17. The third layer 17 is sheet-shaped. The third layer 17 is connected to the first surface 110, disposed away from the second layer 12, overlaps with the sixth end portion 11f, and overlaps with the first end portion 11a. Disposing the third layer 17 provides additional security to the first end portion 11a, thereby reducing the risk of deformation resulting from the separation of the second region 110b from the first region 110a. When viewed in the X direction, the third layer 17 in the Z direction has a ninth end portion 17a and a tenth end portion 17b located opposite the ninth end portion 17a. In the Z direction, a distance D7 between the eighth end portion 12b and the ninth end portion 17a is different from a distance D8 between the ninth end portion 17a and the tenth end portion 17b. In some embodiments, the distance D7 between the eighth end portion 12b and the ninth end portion 17a is shorter than the distance D8 between the ninth end portion 17a and the tenth end portion 17b.

In some embodiments, the third layer 17 includes an insulating material, and the insulating material is selected from at least one of polyethylene, polypropylene, phenolic resin, melamine resin, unsaturated polyester resin, epoxy resin, silicone resin, and polyurethane.

In some embodiments, the third layer 17 is connected to both the first surface portion 117 and the second surface portion 118. Connecting the third layer 17 to both the first surface portion 117 and the second surface portion 118 allows to press tight the stacked portion 11 in the X direction, reducing the risk of deformation caused by displacement of the first conductive layer, second conductive layer, or first layer in the stacked portion 11.

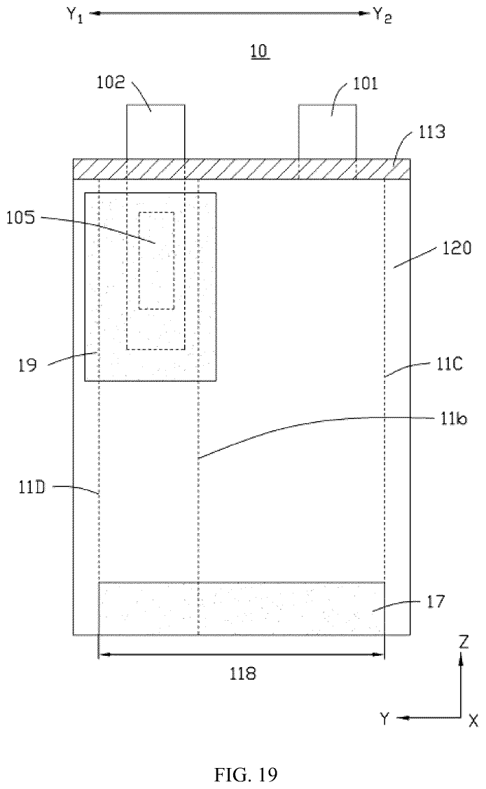

Referring to FIG. 6 and FIG. 19, the first conductive layer 111 includes a first current collector 111a and a first active substance layer 111b. The first current collector 111a includes a first face 31a and a second face 31b that are provided opposite each other. Both the first face 31a and the second face 31b include regions with the first active substance layer 111b and regions without the first active substance layer 111b. The first current collector 111a includes at least one of Ni, Ti, Cu, Ag, Au, Pt, Fe, Co, Cr, W, Mo, Al, Mg, K, Na, Ca, Sr, Ba, Si, Ge, Sb, Pb, In, Zn, and their combinations. The first active substance layer 111b includes at least one of lithium cobalt oxide, lithium manganese oxide, lithium nickel oxide, lithium nickel cobalt manganese oxide, lithium iron phosphate, lithium manganese iron phosphate, lithium vanadium phosphate, lithium vanadium oxide phosphate, lithium-rich manganese-based material, lithium nickel cobalt aluminum oxide, or their combinations.

The regions without the first active substance layer 111b on both the first face 31a and the second face 31b are equipped with a fifth layer 18, and each fifth layer 18 is connected to the first active substance layer 111b. The fifth layer 18 covers the interface between the first active substance layer 111b and the first conductive layer 111, preventing direct contact between the first conductive layer 111 and the second conductive layer 112 caused by the falloff of the first active substance layer 11b, thus preventing short circuits. The first metal plate 101 is welded to the region of the second face 31b away from the first active substance layer 111b. A first welding mark is formed between the first metal plate 101 and the second face 31b (not shown in the figure). One of the fifth layers 18 is disposed on the second face 31b, covering the first metal plate 101 and the first welding mark. Another fifth layer 18 is disposed on the first face 31a, covering the region opposite to the position of the first welding mark on the first face 31a. This can suppress the occurrence of puncturing the first layer 113 due to burrs from the welding mark, thereby preventing short circuits between the first conductive layer 111 and the second conductive layer 112. The fifth layer 18 includes an insulating material, and the insulating material is selected from at least one of polyethylene, polypropylene, phenolic resin, melamine resin, unsaturated polyester resin, epoxy resin, silicone resin, or polyurethane.

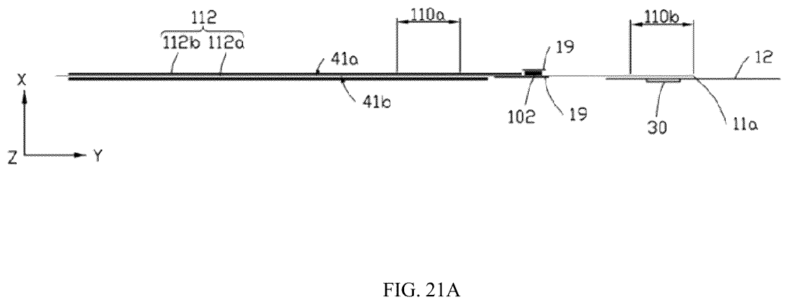

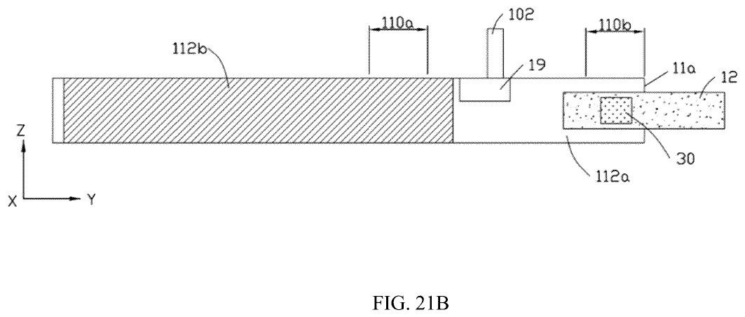

Referring to FIG. 6, FIG. 21A, and FIG. 21B, the second conductive layer 112 includes a second current collector 112a and a second active substance layer 112b. The second current collector 112a includes a third face 41a and a fourth face 41b that are provided opposite each other. Both the third face 41a and the fourth face 41b include regions with the second active substance layer 112b and regions without the second active substance layer 112b. One end of the second current collector 112a is the first end portion 11a. When viewed in the winding direction (along the Y direction) of the stacked portion, the second region 110b is closer to the first end portion 11a than the first region 110a. The second current collector 112a includes at least one of Ni, Ti, Cu, Ag, Au, Pt, Fe, Co, Cr, W, Mo, Al, Mg, K, Na, Ca, Sr, Ba, Si, Ge, Sb, Pb, In, Zn, and their combinations. The second active substance layer 112b can be selected from at least one of graphite materials, alloy materials, and lithium metal or alloys. The graphite material can be selected from at least one of artificial graphite and natural graphite, and the alloy material can be selected from at least one of silicon, silicon oxide, tin, and titanium sulfide. The second metal plate 102 is welded to the region of the third face 41a away from the first active substance layer 111b. On both the third face 41a and the fourth face 41b, regions corresponding to the second metal plate 102 are provided with a fourth layer 19. The fourth layer 19 includes an insulating material, and the insulating material is selected from at least one of polyethylene, polypropylene, phenolic resin, melamine resin, unsaturated polyester resin, epoxy resin, silicone resin, or polyurethane.

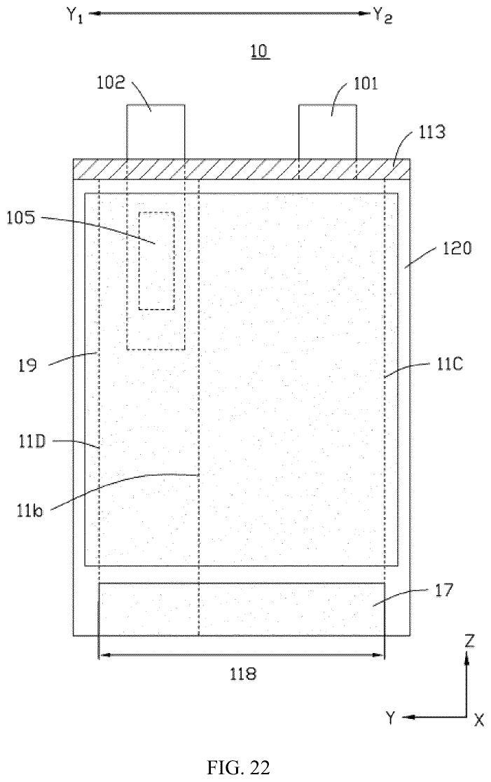

Referring to FIG. 5 and FIG. 6, a second welding mark 105 is formed between the second metal plate 102 and the third face 41a. The second metal plate 102 is connected to the outermost second conductive layer 112 of the wound structure formed by the stacked portion 11, which may result in the protrusion of the welding mark burrs of the second welding mark 105, potentially penetrating the housing. One of the fourth layers 19 is located on the second surface 120. When viewed in the X direction, the fourth layer 19 covers the second welding mark 105 to separate the second welding mark 105 from the housing, thereby reducing issues caused by the welding mark burrs. Referring to FIG. 22, in some other embodiments, when viewed in the X direction, the fourth layer 19 covers the second surface portion 118 in the Y direction and part of the second surface portion 118 in the Z direction. The fourth layer 19 is disposed away from the third layer 17. Increasing an overlapping area between the fourth layer 19 and the second surface portion 118 can improve flatness of the electrode assembly 10.

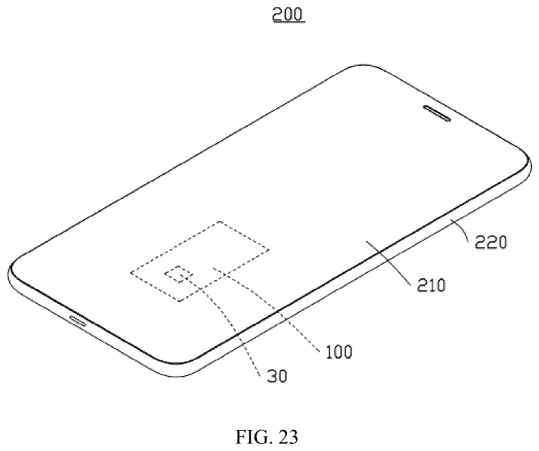

Referring to FIG. 23, this embodiment of this application further provides an electronic apparatus 200, which includes a display screen 210, a body 220, and a battery 100. The display screen 210 is installed on the body 220, and the battery 100 is accommodated the body 220. When viewed in a direction perpendicular to the display screen 210, the identification portion 30 of the battery 100 can be found. In some embodiments, the identification portion 30 is disposed on part of the body 220 located opposite the display screen 210. The electronic apparatus 200 may be one of a mobile phone, a tablet, or an e-reader.

In this application, the electronic apparatus 200 is illustrated as a mobile phone, where the battery 100 is disposed inside the mobile phone to provide power for operation of the mobile phone, and the body 220 represents a structure of the mobile phone. It can be understood that in some other embodiments, the electronic apparatus 200 may have different structures and is not limited to the examples of a mobile phone, a tablet, or an e-reader.

In this application, the identification portion 30 is disposed on the electrode assembly 10 housed in the housing 20 so that the occurrence of situations where the identification portion cannot be identified due to external impacts or friction on the battery 100 can be suppressed. In addition, the identification portion 30 is disposed on the first portion 121 or the second portion 122 of the second layer 12 with a larger area so that the larger area is less likely to fall off the surface of the stacked portion 11 under external forces, reducing risks of smearing and deformation caused by the falloff of the second layer 12.

The specific embodiments and performance of the battery provided in this application are described in the following examples and comparative examples.

### Example 1

The electrode assembly 10 shown in FIG. 11 was used, installed in the housing, followed by injection, packaging, and formation, and a finished battery was obtained. In this case, the identification portion 30 was located on the first portion 121 having a smaller area.

### Example 2

The electrode assembly 10 shown in FIG. 13 was used, installed in the housing, followed by injection, packaging, and formation, and a finished battery was obtained. In this case, the identification portion 30 was located on the second portion 122 having a smaller area.

### Example 3

The electrode assembly 10 shown in FIG. 12 was used, installed in the housing, followed by injection, packaging, and formation, and a finished battery was obtained. In this case, the identification portion 30 covered part of the first end portion 11a.

### Example 4

The electrode assembly 10 shown in FIG. 10 was used, installed in the housing, followed by injection, packaging, and formation, and a finished battery was obtained. In this case, the identification portion 30 was located on the first portion 121 having a larger area.

### Example 5

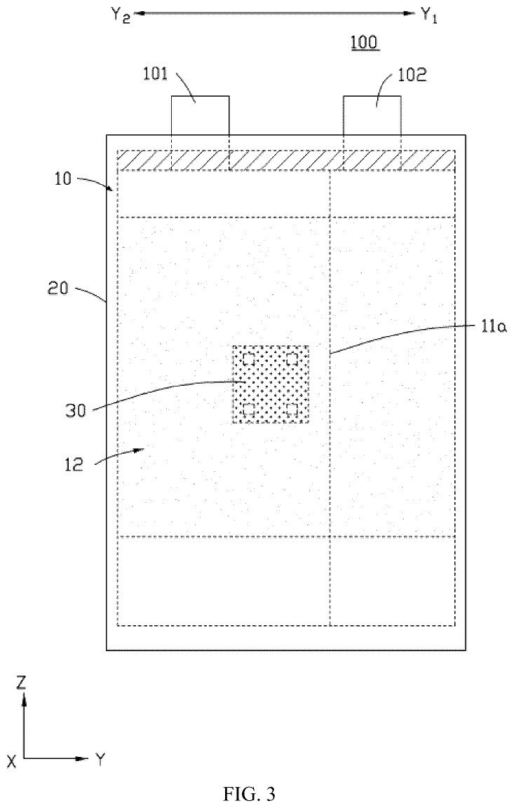

The electrode assembly 10 shown in FIG. 4 was used, installed in the housing 20 (referring to FIG. 3), followed by injection, packaging, and formation, and a finished battery was obtained. In this case, the identification portion 30 was located on the second portion 122 having a larger area.

### Comparative Example 1

An electrode assembly 10 prepared the same as Example 5 was placed in a housing, followed by injection, packaging, and formation, and a finished battery was obtained. The difference is that the identification portion 30 is located on the outer surface of the housing.

In this application, the identification portion 30 located on the outer surface of the housing can have a similar structure to the identification portions provided in Examples 1 to 5, can be disposed using similar methods, and can be used to record information.

Drop tests were conducted on 20 sample batteries in the comparative example.

For each group of example batteries, 20 samples were selected for drop tests and cycling tests. The test results are shown in Table 1.

Drop tests: The battery samples were placed in a fixture and subjected to 10 drop tests from a height of 1.8 m. The number of damaged identification portions was recorded. Damage was determined by viewing the identification portions after the test. If they are unidentifiable, they are considered damaged.

Cycling tests: The battery samples were charged at a constant current of 0.2 C to 4.45 V, then charged at a constant voltage of 0.05 C, and discharged at 0.2 C to 3 V. This charge/discharge cycling was repeated 1000 times. The number of deformed identification portions was recorded. Deformation was determined by comparing the size of the identification portions in one direction before and after the cycling test. If the size increase rate after the cycling test ≥3%, the identification portion was considered deformed.

TABLE 1

| | Smearing of | Deformation of |
|---|---|---|
| | identification portion | identification portion |
| | in drop test | in cycling test |
| Comparative | 20/20 | / |
| example 1 | | |
| Example 1 | 10/20 | 10/20 |
| Example 2 | 9/20 | 9/20 |
| Example 3 | 10/20 | 9/20 |
| Example 4 | 0/20 | 0/20 |
| Example 5 | 0/20 | 0/20 |

Note:
X/20 indicates the number of samples being X out of 20 in which the identification portion is contaminated or deformed.

It can be seen from the test results shown in Table 1 that in comparison between examples 1 to 5 and comparative example 1, when the identification portion is disposed on the outer surface of the housing, a smearing probability of the identification portion during drop test is relatively high. When the identification portion is disposed on the surface of the electrode assembly inside the housing, the smearing probability of the identification portion is relatively low.

It can be seen from the comparison of examples 1 to 5, when the identification portion is disposed on the portion with a larger area of the second layer that overlaps with the first region or the second region, a deformation probability of the identification portion during the charge/discharge cycling of the battery is relatively low.

The descriptions disclosed above are only the preferred embodiments of this application, and do not, certainly, constitute limitation to this application. Accordingly, any equivalent changes made in accordance with this application still fall within the scope of this application.

What is claimed is:

1. A battery comprising an electrode assembly, wherein the electrode assembly comprises a stacked portion and a second layer; the stacked portion comprises a first conductive layer, a second conductive layer, and a first layer arranged between the first conductive layer and the second conductive layer; the first layer comprising an insulating material; wherein
the stacked portion is configured as a wound structure and further comprises a first surface and a first end portion;
a thickness direction of the electrode assembly is defined as a first direction, and when viewed in the first direction, the first surface has a first region located on a first side of the first end portion and a second region located on a second side of the first end portion; wherein in a second direction perpendicular to the first direction, the first side and the second side are located on two opposite sides of the first end portion; and in a winding direction of the stacked portion, the second region is closer to the first end portion than the first region; and
the second layer covers at least a portion of the first end portion and is connected to the first region and the second region, and the second layer is provided with an identification portion.

2. The battery according to claim 1, wherein when viewed in the first direction, the second layer comprises a first portion overlapping with the first region and a second portion overlapping with the second region, and the identification portion is disposed on at least one of the first portion or the second portion, and the identification portion is separated from the first end portion.

3. The battery according to claim 2, wherein the identification portion is disposed on the one having a larger area as compared to the other selected from the first portion and the second portion.

4. The battery according to claim 2, wherein the identification portion is disposed on the one having a smaller area as compared to the other selected from the first portion and the second portion.

5. The battery according to claim 1, wherein when viewed in the first direction, the identification portion covers at least a portion of the first end portion.

6. The battery according to claim 1, wherein when viewed in the first direction, the stacked portion has a third end portion and a fourth end portion located opposite to the third end portion in the second direction; and
when viewed in the first direction, the second layer is arranged from the third end portion to the fourth end portion.

7. The battery according to claim 1, wherein when viewed in the first direction, the stacked portion has a fifth end portion and a sixth end portion located opposite to the fifth end portion in a third direction perpendicular to the first direction and the second direction; and
when viewed in the first direction, the second layer is separated from the fifth end portion and the sixth end portion.

8. The battery according to claim 7, wherein in the third direction, the second layer has a seventh end portion located on a side of the fifth end portion and an eighth end portion located opposite to the seventh end portion and on a side of the sixth end portion; and
in the third direction, a distance from the fifth end portion to the seventh end portion is shorter than a distance from the sixth end portion to the eighth end portion.

9. The battery according to claim 7, wherein the electrode assembly further comprises a first metal plate, wherein the first metal plate is connected to the first conductive layer; and when viewed in the first direction, the first metal plate has a portion overlapping with the fifth end portion.

10. The battery according to claim 6, wherein in the second direction, a distance from the first end portion to the third end portion is longer than a distance from the first end portion to the fourth end portion.

11. The battery according to claim 1, wherein the stacked portion further comprises a first bent portion, a second bent portion located opposite to the first bent portion in the second direction, a first surface portion located between the first bent portion and the second bent portion when viewed in the first direction, and a second surface portion located between the first bent portion and the second bent portion and facing towards an opposite face of the first surface portion when viewed in the first direction.

12. The battery according to claim 11, wherein the second layer is connected to all of the first surface portion, the first bent portion, and the second bent portion.

13. The battery according to claim 12, wherein in the winding direction of the stacked portion, the identification portion is separated from the first bent portion and the second bent portion.

14. The battery according to claim 11, wherein when viewed in the first direction, the stacked portion has a third end portion and a fourth end portion located opposite to the third end portion in the second direction, and the stacked portion has a fifth end portion and a sixth end portion located opposite to the fifth end portion in a third direction perpendicular to the first direction and the second direction.

15. The battery according to claim 14, wherein when viewed in the first direction, the electrode assembly comprises a third layer containing an insulating material, the third layer is connected to the first surface and has a portion overlapping with the sixth end portion, and in the third direction, the third layer is separated from the second layer.

16. The battery according to claim 15, wherein the third layer is connected to both the first surface portion and the second surface portion; wherein
the third layer has a ninth end portion and a tenth end portion located opposite to the ninth end portion in the third direction, the second layer has a seventh end portion and an eighth end portion located opposite to the seventh end portion and on a side of the tenth end portion in the third direction; and in the third direction, a distance from the eighth end portion to the ninth end portion is different from a distance from the ninth end portion to the tenth end portion.

17. The battery according to claim 16, wherein the distance from the eighth end portion to the ninth end portion is shorter than the distance from the ninth end portion to the tenth end portion.

18. The battery according to claim 1, wherein the electrode assembly further comprises a second metal plate, the second metal plate is welded to the outermost second conductive layer of the wound structure formed by winding the stacked portion, a welding mark is formed between the second metal plate and the second conductive layer, the stacked portion further comprises a second surface located opposite to the first surface, the second surface is provided with a fourth layer, and when viewed in the first direction, the fourth layer covers the welding mark.

19. The battery according to claim 1, wherein the battery further comprises a housing accommodating the electrode assembly, wherein
at least a portion of an inner side of the housing facing towards a surface of the electrode assembly is provided with a conductive material.

20. An electronic apparatus, wherein the electronic apparatus comprises a battery; wherein
the battery comprising an electrode assembly, wherein the electrode assembly comprises a stacked portion and a second layer; the stacked portion comprises a first conductive layer, a second conductive layer, and a first layer arranged between the first conductive layer and the second conductive layer; the first layer comprising an insulating material; wherein
the stacked portion is configured as a wound structure and further comprises a first surface and a first end portion;
a thickness direction of the electrode assembly is defined as a first direction, and when viewed in the first direction, the first surface has a first region located on a first side of the first end portion and a second region located on a second side of the first end portion, wherein in a second direction perpendicular to the first direction, the first side and the second side are located on two opposite sides of the first end portion; and in a winding direction of the stacked portion, the second region is closer to the first end portion than the first region; and
the second layer covers at least a portion of the first end portion and is connected to the first region and the second region, and the second layer is provided with an identification portion.
